(19) United States
(12) Patent Application Publication
(10) Pub. No.: US 2005/0154886 A1
(43) Pub. Date: Jul. 14, 2005

(54) Declarative trust model between reverse proxy server and websphere application server

(75) Inventors: Peter Daniel Birk, Austin, TX (US); Ching-Yun Chao, Austin, TX (US); Hyen Vui Chung, Round Rock, TX (US); Ajay Reddy Karkala, Austin, TX (US); Carlton Keith Mason, Austin, TX (US); Nataraj Nagaratnam, Morrisville, NC (US); Brian Keith Smith, Raleigh, NC (US); Vishwanath Venkataramappa, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/755,828

(22) Filed: Jan. 12, 2004

(51) Int. Cl. H04L 9/00

(52) U.S. Cl. 713/168

(57) ABSTRACT

A method and system for providing a declarative trust association model that formalizes the way trust is established and requires corresponding authentication information to be presented in a standard format. Consequently, the application server may provide a guaranteed level of protection. The mechanism of the present invention provides a framework that allows an application server to enforce a trust evaluation and allows reverse proxy security server to assert a client's security identity, as well as other client security credential information. A known trust association interceptor model is extended to allow the reverse proxy security server to assert the authenticated user's security attributes. Such security attributes include, for example, group information, authentication strength, and location (i.e., where does the user enter the request, intranet vs. internet, IP address, etc.,). The security attributes can be used in making authorization decisions.

### BACKGROUND OF THE INVENTION

1. Technical Field

The present invention provides an application server framework for identifying and validating a web request. More specifically, the present invention is directed to a method and system for formalizing the way trust may be established and presenting the corresponding authentication information in a standard format.

2. Description of Related Art

Application servers are software applications in an intranet/Internet environment that host a variety of language systems used to program database queries and/or perform general business processing. The application server may reside in the same computer as a Web server, i.e. the HyperText Transport Protocol (HTTP) server, or may be in a separate computer. In large Web sites, multiple processors, or multiple computers, are used for both application servers and Web servers (HTTP servers). An example of a Web application server is WebSphere Application Server. WebSphere is a registered trademark of International Business Machines (IBM) Corporation.

When integrating a third party application such as, for example, the WebSphere Application Server, it is desirable to authenticate the client browser once by including a mechanism for propagating client security credentials among servers from different vendors. This one-time authentication is known as a single sign-on (SSO). Single sign-on allows credential mapping among many diverse systems. A typical single sign-on scenario includes web servers situated in a DMZ, or demilitarized zone, and application servers located on the intranet behind a firewall. A DMZ provides a haven for machines that are exposed to the Internet. Machines in the DMZ may be reached from the internal network or the Internet. However, those machines may not reach back into the internal network to contact hosts within.

It is common practice in enterprise information technology (IT) infrastructure to use a reverse proxy server to authenticate Internet user requests and to perform coarse-grained access control within the DMZ so that unauthorized user requests are rejected before entering the intranet. A trust association interceptor (TAI) may be used to validate the trust relationship between the application server and the proxy server. The TAI model offers a performance advantage since authenticating a user involves either accessing an authentication service and/or a user registry and is an expensive process, and the TAI model avoids duplicative authentication processes at the application server by employing single sign-on. After validating the proxy server authentication data, the TAI returns the identities of the authenticated users to the application server. The application server may then assert the identities of those users based on the validated trust relationship.

However, drawbacks associated with the known TAI trust model are present. For example, in a WebSphere Application Server, the trust association interceptor is employed to validate the trust established between the proxy server and the application server. Based on the trust claimed by the TAI interceptor, the application server then converts the client identity to a WebSphere security credential. A problem associated with this approach is that the WebSphere Application Server does not enforce the trust established between the proxy server and the application server. Furthermore, this approach requires that the WebSphere Application Server perform a credential conversion. Without enforcing the trust, WebSphere Application Server cannot provide assured quality of security service to an administrator when a TAI interceptor is added into the application server configuration. Moreover the credential mapping represents a redundancy that may be removed.

Furthermore, the TAI model may be generalized as “identity assertion”, whereby a server that is trusted by the application server may assert the client's security identity. However, no formal way of defining and determining the strength of the trust relationship is present. The current TAI model only allows asserting the identity of the user. Any user security credentials information other than the identity of the user that is obtained by a reverse proxy security server during the authentication process is not propagated to the application server.

Thus, it would be advantageous to have an improved application server framework that allows an application server to enforce a trust evaluation, such that the application server may provide a guaranteed level of protection. It would further be advantageous to have a method and system that supports the direct propagation of client security credentials from a third party security provider to an application server in order to facilitate security credentials assertion.

### SUMMARY OF THE INVENTION

The present invention provides a method and system for allowing an application server to enforce a trust evaluation of a third party. When a user request is received from a third part, the application server extracts authentication data from the third party. The application server validates the authentication data, wherein the validation allows the application server to enforce the trust evaluation. The application server then performs credential mapping using the validated authentication data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in accordance with a preferred embodiment of the present invention;

FIG. 2 is an exemplary block diagram of a server computing device in accordance with a preferred embodiment of the present invention;

FIG. 3 is an exemplary block diagram of a client computing device in accordance with a preferred embodiment of the present invention;

FIG. 4 is a block diagram of a known trust association interceptor model;

FIG. 5 is an exemplary block diagram of a declarative trust association framework in accordance with a preferred embodiment of the present invention; and

FIG. 6 is a flowchart of an exemplary process of formalizing the way trust is established in accordance with a preferred embodiment of the present invention.

### DETAILED DESCRIPTION OF THE PREFERRED EMBODIMENT

The present invention is directed to allowing an application server computing device of an enterprise data processing system to enforce a trust evaluation. In particular, the present invention provides a framework for formalizing the way trust may be established between a web application server and a reverse proxy security server and presenting the corresponding authentication information in a standard format.

With the present invention, a known trust association interceptor model is extended to allow the application server to assert the authenticated user's security attributes. Such security attributes include, for example, group information, authentication strength, and location (i.e., where does the user enter the request, intranet vs. internet, IP address, etc.). The security attributes can be used in making authorization decisions. Consequently, the application server may provide a guaranteed level of protection not present in the prior art.

In a preferred embodiment, the present invention is implemented using a WebSphere Application Server. A brief explanation of the elements of a distributed data processing system is provided in order to provide a context for the description of the present invention.

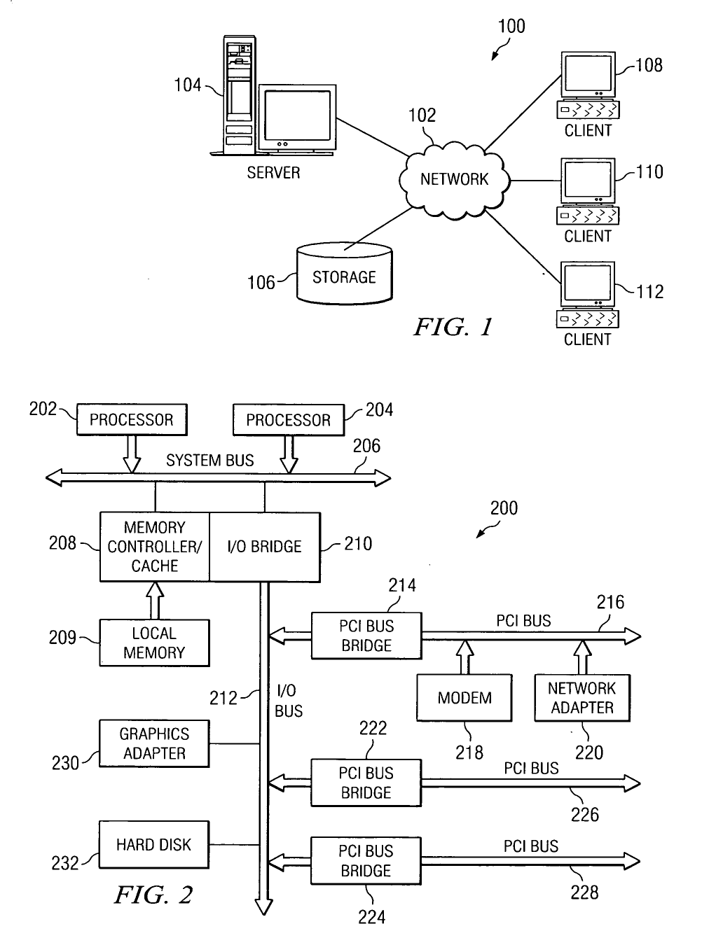

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Server 104 may function as an application server, such as WebSphere Application Server available from International Business Machines Corporation. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

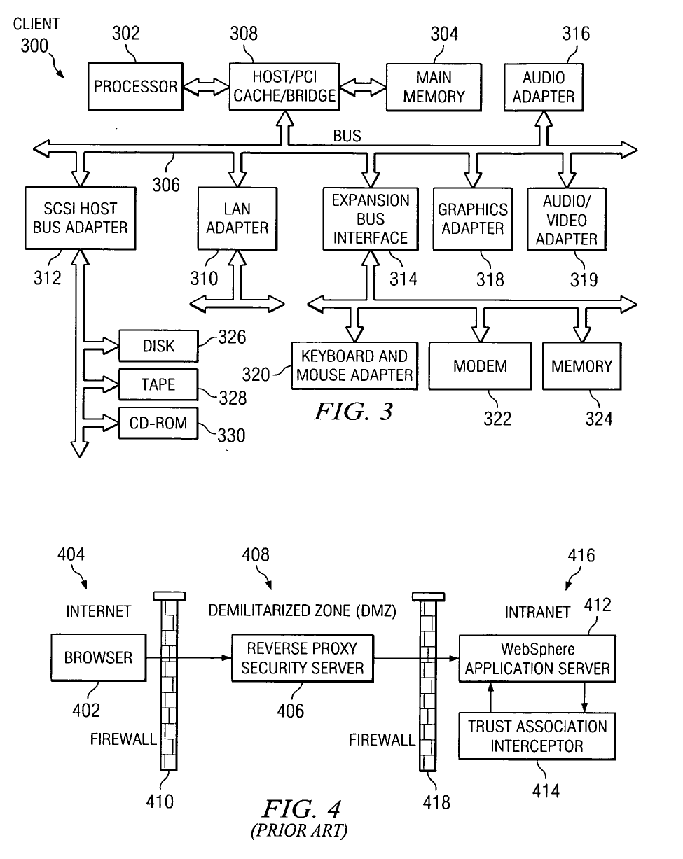

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As previously mentioned above, the present invention provides a framework that allows an application server to enforce a trust evaluation. The present invention provides an improvement over known systems by providing a formal way of defining and determining the strength of the trust relationship, and allowing an application server to assert a client's security identity, as well as other client security credential information. Although known systems may assert the identity of the user, user security credentials information other than the identity of the user obtained by a reverse proxy security server during the authentication process is not propagated to the application server.

Turning now to FIG. 4, a block diagram of a known trust association interceptor model is shown. A typical single sign-on scenario includes client browser 402 located on Internet 404, reverse proxy security server 406 situated in demilitarized zone (DMZ) 408 behind firewall 410, and application server 412 with trust association interceptor 414 located on intranet 416 behind firewall 418. Application server 412 is process that may be located on a server, such as server 104, as shown in FIG. 1. Since it is desirable to prevent unauthorized Web requests from being forwarded from a Web server to the intranet, authentication and some degree of access control will be performed within the DMZ in order to filter out unauthorized web requests. Reverse proxy security servers, such as reverse proxy security server 406, may be used within DMZ 408 to authenticate internet user requests and to perform coarse-grained access control so that unauthorized user requests are rejected before entering intranet 416. The delegation of authentication to reverse proxy security server 406 requires the establishment of a trust relationship between application server 412 and reverse proxy security server 406. In other words, reverse proxy security server 406 authenticates the clients for application server 412, which consequently accepts the authentication because application server 412 in FIG. 4 trusts reverse proxy security server 406.

Client browser 402 first sends an HTTP request that is intercepted by reverse proxy security server 406 situated within DMZ 408. Reverse proxy security server 406 receives the request from client browser 402 and authenticates the client browser user identity. Reverse proxy security server 406 then adds the client security credential to the web request when it forwards the request to application server 412 located on intranet 416.

Application server 412 receives the authenticated browser user identity from reverse proxy security server 406. Trust association interceptor (TAI) 414 is used to validate the trust relationship between application server 412 and reverse proxy security server 406. The trust relationship between a reverse proxy security server and an application server may be established in various ways, including Mutual Secure Socket Layer (SSL) authentication (i.e., the two servers verify the X509 certificate of one another other while establishing an SSL connection), authenticating a reverse proxy security server's basic authentication data (e.g., ID and password), validating a reverse proxy security server's security token (e.g., Kerberos service ticket, etc.), and validating a reverse proxy security server's ID. In this manner, a trust relationship is established between secure reverse proxy server 406 and application server 412 and validated by TAI 414. Consequently, application server 412 is able to accept and process the web requests via reverse proxy security server 406 rather than having the requests come directly from client browser 402.

After validating the proxy server authentication data to establish trust, TAI 414 asserts the browser user identity based on the trust. TAI 414 also returns authenticated browser user identity security credentials to application server 414. Application server 414 may then assert the identities of those users based on the trust relationship.

Conventional authentication methods that employ a third party TAI implementation to enforce the trust policy are often faced with the issue of which party should provide and support the trust association interceptor. The present invention solves this problem by providing a declarative trust association model that permits the application server to enforce the trust policy. The present invention implements a trust evaluation framework by employing a Java Authentication and Authorization Service (JAAS) API within the application server framework to perform authentication of a client browser. JAAS is a package that enables services to authenticate and enforce access controls upon users. JAAS implements a Java version of the standard Pluggable Authentication Module (PAM) framework, and supports user-based authorization.

In particular, the application server enforces the trust and authentication requirement by providing an implementation that examines and verifies the asserted HTTP headers. For example, WebSphere Application Server provides a set of Callbackhandler and LoginModule implementation combinations that may be configured by users to enforce different level of trust and authentication strength. Two plug-in interfaces WebSphere may use to plug-in the implementation: (1) TAI interceptor plug-in and (2) JAAS LoginModule plug-in.

With regard to the TAI interceptor plug-in, the present invention extends the TAI interface so that a TAI interceptor implementing the enhanced TAI interface may validate the authenticated data in the HTTP headers and return client credentials in a JAAS Subject.

With regard to the JAAS LoginModule plug-in, the application server passes the various HTTP headers to the LoginModule via a Callback array. For example, a WebSphere CallbackHandler may prepare the Callback array and examine the HTTP headers. The WebSphere CallbackHandler may then extract the asserted authentication data. In this manner, different WebSphere CallbackHandlers may be used to construct various Callback array combinations.

For example, in one mode (identity assertion), a CallbackHandler will examine the HTTP headers, WSSEC_SERVER_TOKEN and WSSEC_CLIENT_IS, to obtain required authentication information. WSSEC_SERVER_TOKEN is verified by the LoginModule to validate the trust to the server that asserts the client identity. WSSEC_SERVER_TOKEN may contain either a reverse proxy server id and password, or a reverse proxy server security token (authentication service dependent). Both may require a different CallbackHandler. In the second mode, WebSphere allows the reverse proxy server to pass the client security token to WebSphere. WebSphere may use the authentication service to validate the client security token.

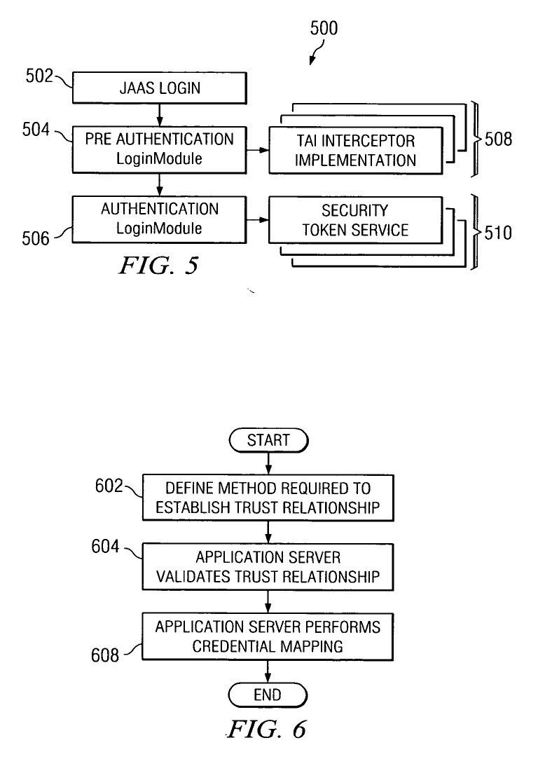

Turning now to FIG. 5, an exemplary block diagram of a declarative trust association framework in accordance with a preferred embodiment of the present invention is shown. Declarative trust association framework 500 is a policy based trust association model that defines the method required to establish a trust relationship. Although the declarative trust association framework implementation as shown in FIG. 5 of the present invention uses HTTP protocol, this HTTP implementation is for example purposes only. The declarative trust association framework of the present invention is communication protocol independent.

The method of implementing the particular authentication method used may be specified in the trust association policy. For example, if employing a basic authorization method (e.g., ID and password), the HTTP header contains reverse proxy security server (RPSS) ID and password. A TAI implementation then returns the ID and password of the reverse proxy server along with the authenticated user identity for the application server to validate.

Another authentication method includes having the application server authenticate a reverse proxy security server's security token (e.g., Kerberos service ticket, etc.), but the HTTP header contains a security token that can be validated by the application server. Ideally, the security token can demonstrate that the reverse proxy server does own the security token. A TAI implementation then returns the security token along with the authenticated user identity for the application server to validate.

A further authentication implementation includes a Mutual Secure Socket Layer (SSL) authentication (i.e., the two servers verify the X509 certificate of one another other while establishing an SSL connection). The HTTP header contain a certificate (chain) of the reverse proxy security server, whereby the certificate was used in establishing the SSL transport connection. A TAI implementation then returns the certificate chain along with the authenticated user identity for the application server to validate.

Another authentication method implementation includes employing a digital signature. In this method, the HTTP header contains a RPSS digital signature and X590 certificate chain along with the authenticated user identity. A TAI implementation then returns the digital signature and the certificate chain along with the authenticated user identity for the application server to validate.

As shown in FIG. 5, the declarative trust association framework of the present invention comprises the following components: JAAS Login 502, PreAuthentication LoginModule 504, Authentication LoginModule 506, trust association interceptors 508, and security token services 510, all of which are located on an application server, such as application server 412 in FIG. 4. JAAS Login 502 specifies a named configuration to load. The JAAS Login is used to load the configuration information from the Websphere configuration repository, which in turn tells JAAS Login which login method to use during the login. PreAuthentication LoginModule 504 prepares a JAAS Callback array by extracting authentication information from a specified JAAS CallbackHandler.

When trust association interceptor(s) 508 are enabled, PreAuthentication LoginModule 504 invokes the trust association interceptor(s) to extract the required reverse proxy security server authentication data and the authenticated client identity. Trust association interceptors 508 are necessary in HTTP requests because there may not be a standardized method for required reverse proxy security server to insert its authentication data into the user request. After the first trust association interceptor adds the authentication data to the Callback array, the PreAuthentication LoginModule process is stopped.

Authentication LoginModule 506 provides the interface to specific authentication mechanisms. Based on the trust policy, Authentication LoginModule 506 validates the trust relationship with the reverse proxy security server (RPSS) using the required RPSS authentication data in the Callback array. After the trust relationship is validated, Authentication LoginModule 506 asserts the authenticated user identity. Authentication LoginModule 506 then locates the user's security attributes from the user registry and populates these attributes into the authenticated user's JAAS Subject. The Subject represents an authenticated entity and includes the identities and public and private credentials of the entity.

Authentication LoginModule 506 may also invoke third party security token services 510 to validate security tokens. Security token services 510 may be implemented as a component running in the WebSphere Application server address space or as a remote server.

Like the known TAI authentication model, the trust relationship between a reverse proxy security server and the application server in the declarative trust association model may be established in various ways, including through basic authentication (reverse proxy server id and password), a Security Token (Kerberos Service ticket that can be validated or other type of tokens), SSL Mutual Authentication, and the like. However, in the declarative trust association model, the trust policy is enforced by the application server rather than the third party trust association interceptor implementation. By having the application server enforce the trust policy, the strength of the trust relationship may be determined. In addition, the application server provides a set of Callbackhandler and LoginModule implementation combinations that may be configured by users to enforce different level of trust and authentication strength.

Furthermore, the known TAI implementation requires that the required authentication information be returned to the reverse proxy security server. In contrast, the declarative trust association model does not dictate the exact format to propagate the required authentication data. The third party reverse proxy security server has the flexibility to define its own format.

With reference now to FIG. 6, a flowchart outlining an exemplary process of formalizing the way trust may be established in accordance with a preferred embodiment of the present invention is shown. The process begins by defining the method required to establish the trust relationship (step 602). Methods may include, for example, basic authentication, whereby basic authentication data of third party secure reverse proxy server may be passed via BasicAuth data in the HTTP header, security token and digital signature, whereby a new name value pair, of named piece of data, will be defined to pass server security token and digital signature of third party reverse proxy server, and SSL, whereby an indicator signaling the use of SSL is passed.

With a standardized way to pass third party authentication information, the application server will be able to validate and enforce the trust relationship (step 604). Once the trust relationship is validated by the application server, the application server will then perform credential mapping (step 608).

Note that with the present invention, there is no need for the third party reverse proxy server to plug-in a trust association interceptor. Logically, a TAI interceptor should be provided by a third party security provider because there is a corresponding piece of code on the proxy server side to perform identity assertion. Alternatively, a reverse proxy server code may insert authentication information accordingly to WebSphere defined format so that the information can be processed by WebSphere Pre-Authentication LoginModule. With the present invention, duplicate code in the TAI interceptors may be eliminated, as well as eliminating the need to develop and maintain TAI interceptors.

As explained previously, the original TAI model only allows asserting an authenticated user's identity based on the trust relationship. With the present invention, direct propagation of client security credentials from third party security providers to the application server is supported by the pluggable authentication framework. Thus, the disadvantages of known application server systems are avoided by extending the known TAI model to allow a reverse proxy security server to assert the authenticated user's security attributes. Such security attributes include, for example, group information, authentication strength, and location (i.e., where does the user enter the request, intranet vs. internet, IP address, etc.,). These security attributes can be used in making authorization decisions.

Thus, the present invention provides a method and system for formalizing the way trust may be established and requiring corresponding authentication information to be presented in a standard format. The advantages of the present invention should be apparent in view of the detailed description provided above. The application server may enforce the claimed level of trust, thereby providing a quality of protection guarantee to users. In addition, there is no need to implement a different trust association interceptor for each different kind of third party product. Furthermore, the present invention allows passing client security tokens, which offers a higher level of protection because the strength of the identity assertion is as strong as the authentication of the third party product's identity.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for allowing an application server to enforce a trust evaluation of a third party, comprising:
receiving a user request from a third party;
extracting authentication data from the third party;
validating the authentication data at the application server, wherein the validation allows the application server to enforce the trust evaluation; and
performing credential mapping using the validated authentication data.

2. The method of claim 1, wherein different levels of trust and authentication strengths are used to enforce the trust evaluation.

3. The method of claim 2, wherein the different levels of trust and authentication strengths are enforced by using at least one of a Callbackhandler plug-in and LoginModule plug-in.

4. The method of claim 1, wherein the application server defines a standard set of Hypertext Transfer Protocol (HTTP) headers.

5. The method of claim 4, wherein authentication data in the set of Hypertext Transfer Protocol (HTTP) headers is passed to the application server from the third party.

6. The method of claim 1, wherein the third party is at least one of a reverse proxy server and a web server plug-in.

7. The method of claim 1, wherein the authentication data comprises third party server authentication data and client id.

8. The method of claim 7, wherein the third party server authentication data includes at least one of an id/password, security token, and digital signature.

9. The method of claim 1, wherein the authentication data comprises client authentication data.

10. The method of claim 9, wherein the client authentication data includes at least one of an id/password, security token, and digital signature.

11. The method of claim 1, wherein the third party directly propagates client security credentials to the application server via a pluggable authentication framework.

12. The method of claim 1, wherein allowing the application server to enforce the trust evaluation includes allowing the reverse proxy security server to assert an authenticated user's security attributes.

13. The method of claim 12, wherein the security attributes includes group information, authentication strength, and location.

14. A data processing system for allowing an application server to enforce a trust evaluation of a third party, comprising:
receiving means for receiving a user request from a third party;
extracting means for extracting authentication data from the third party;
validating means for validating the authentication data at the application server, wherein the validation allows the application server to enforce the trust evaluation; and
performing means for performing credential mapping using the validated authentication data.

15. The data processing system of claim 14, wherein different levels of trust and authentication strengths are used to enforce the trust evaluation.

16. The data processing system of claim 15, wherein the different levels of trust and authentication strengths are enforced by using at least one of a Callbackhandler plug-in and LoginModule plug-in.

17. The data processing system of claim 14, wherein the application server defines a standard set of Hypertext Transfer Protocol (HTTP) headers.

18. The data processing system of claim 17, wherein authentication data in the set of Hypertext Transfer Protocol (HTTP) headers is passed to the application server from the third party.

19. The data processing system of claim 14, wherein the third party is at least one of a reverse proxy server and a web server plug-in.

20. The data processing system of claim 14, wherein the authentication data comprises third party server authentication data and client id.

21. The data processing system of claim 20, wherein the third party server authentication data includes at least one of an id/password, security token, and digital signature.

22. The data processing system of claim 14, wherein the authentication data comprises client authentication data.

23. The data processing system of claim 22, wherein the client authentication data includes at least one of an id/password, security token, and digital signature.

24. The data processing system of claim 14, wherein the third party directly propagates client security credentials to the application server via a pluggable authentication framework.

25. The data processing system of claim 14, wherein allowing the application server to enforce the trust evaluation includes allowing the reverse proxy security server to assert an authenticated user's security attributes.

26. The data processing system of claim 25, wherein the security attributes includes group information, authentication strength, and location.

27. A computer program product in a computer readable medium for allowing an application server to enforce a trust evaluation of a third party, comprising:
first instructions for receiving a user request from a third party;
second instructions for extracting authentication data from the third party;
third instructions for validating the authentication data at the application server, wherein the validation allows the application server to enforce the trust evaluation; and
fourth instructions for performing credential mapping using the validated authentication data.

28. The computer program product of claim 27, wherein different levels of trust and authentication strengths are used to enforce the trust evaluation.

29. The computer program product of claim 28, wherein the different levels of trust and authentication strengths are enforced by using at least one of a Callbackhandler plug-in and LoginModule plug-in.

30. The computer program product of claim 27, wherein the application server defines a standard set of Hypertext Transfer Protocol (HTTP) headers.

31. The computer program product of claim 30, wherein authentication data in the set of Hypertext Transfer Protocol (HTTP) headers is passed to the application server from the third party.

32. The computer program product of claim 27, wherein the third party is at least one of a reverse proxy server and a web server plug-in.

33. The computer program product of claim 27, wherein the authentication data comprises third party server authentication data and client id.

34. The computer program product of claim 33, wherein the third party server authentication data includes at least one of an id/password, security token, and digital signature.

35. The computer program product of claim 27, wherein the authentication data comprises client authentication data.

36. The computer program product of claim 35, wherein the client authentication data includes at least one of an id/password, security token, and digital signature.

37. The computer program product of claim 27, wherein the third party directly propagates client security credentials to the application server via a pluggable authentication framework.

38. The computer program product of claim 27, wherein allowing the application server to enforce the trust evaluation includes allowing the reverse proxy security server to assert an authenticated user's security attributes.

39. The computer program product of claim 38, wherein the security attributes includes group information, authentication strength, and location.
